(19) United States
(12) Patent Application Publication
(10) Pub. No.: US 2005/0154643 A1
(43) Pub. Date: Jul. 14, 2005

(54) Purchasing information requested and conveyed on demand

(75) Inventors: Christopher Hoang Doan, Austin, TX (US); Liliana Orozco, Del Valle, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/753,686

(22) Filed: Jan. 8, 2004

(51) Int. Cl. G06F 17/60

(52) U.S. Cl. 705/26

(57) ABSTRACT

A system and method for conducting safe transactions for online purchases. A user requests a temporary number with which to complete an online transaction, such as a temporary credit card number. The temporary number issuer, such as a credit card company, associates the temporary number with the user. The user enters the temporary number at an online store, and the online store charges the credit card company for the purchase, and the credit card company then charges the user for the purchase.

### BACKGROUND OF THE INVENTION

1. Technical Field

The present invention relates generally to methods of online purchasing, and specifically to use of disposable information to safely conduct transactions.

2. Description of Related Art

The Internet has become a common tool for conducting business transactions. Frequently, buyers shop for items online at store websites, and purchases are often made at “online stores”. In such transactions, purchasers send relevant information, such as personal information (e.g., name, address, contact information) as well as financial information (e.g., credit card number and expiration date) to the server hosting the store's website. Fear that such sensitive information will be exposed to unauthorized people is furthered by reminders that servers are subject to hacker attacks and theft of database information, such as the credit card information of customers who made purchases at that store.

Identity theft, where a thief poses as another person using the victim's personal and financial information, has become a familiar term in recent years. Such fraud is difficult to avoid for consumers, who have little or no control over how an online vendor protects or uses the personal information it gathers. The threat of identity theft also makes Internet transactions seem more risky than face-to-face transactions. Though consumers can often avoid paying for items they did not purchase, identity theft is still costly because it makes shoppers nervous and skeptical about entering credit card information online, and because of difficulty in proving such theft.

Prior art systems to address fraud for online purchases have been attempted, including systems that require a user to visit a specific website at each online purchase in order to acquire a temporary credit card number. For example, a user visits a merchant site and wishes to make a purchase. The user must, prior to making the purchase, visit another website owned by the temporary card number issuer to get a temporary credit card number. The temporary number issuer generates a card number with an expiration date the customer can use to make a purchase at a merchant's website. In some systems, the customer downloads software to their computer and uses this software to link to the temporary card number issuer and to receive a temporary number. These systems require a user to open a second browser instance or an instance of the downloaded software in order to get a temporary number.

Drawbacks to current systems include the need to download proprietary software or to connect to a website during the purchase process in order to receive the temporary number. In such cases, the number is transmitted across the Internet, and is vulnerable to online snoopers.

Therefore, there is a need in the art for a way to conduct online transactions that prevents identity thieves from accessing a shopper's credit card and other personal information, but which does not require transmission across the Internet of the customer's personal information.

### SUMMARY OF THE INVENTION

The present invention teaches a system and method for conducting purchase transactions that use a disposable credit card number or other disposable account identifier. In one example embodiment, a buyer that wishes to make a credit card purchase at an online store contacts the buyer's credit card company, and the credit card company (preferably after proper authentication and verification) issues a temporary or one-time use credit card number to the buyer. The credit card company also maps this temporary credit card number to the personal information of the buyer. The buyer receives the temporary credit card number on the buyer's cell phone, preferably with some security or authentication procedure, and enters it, for example, at an online store's transaction or checkout web page. Once the temporary number is used, or after a short time period elapses, the temporary number expires and may not be used. The online store charges the credit card company, which charges the buyer's account for the transaction.

Advantages and other implementations of the present invention are described more fully in the detailed description, below.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a networked computer system, consistent with implementing a preferred embodiment of the present invention.

FIG. 2 shows a plurality of devices, some of which are networked, consistent with implementing a preferred embodiment of the present invention.

FIG. 3 shows a process flow for implementing a preferred embodiment of the present inventions.

FIG. 4 shows a process flow for implementing a preferred embodiment of the present invention.

### DETAILED DESCRIPTION OF THE PREFERRED EMBODIMENT

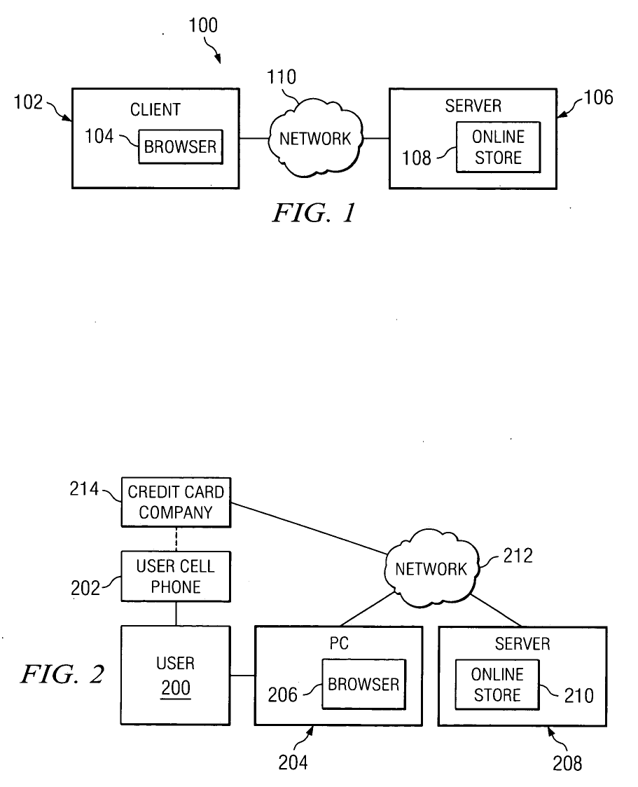

FIG. 1 shows a networked computer system consistent with implementing a preferred embodiment of the present invention. In this example, a networked computer environment 100 is shown. Client 102 is connected to network 110 which provides a communication link to server 106. Server 106 is typically located remotely and, in a preferred embodiment, hosts web sites including online store 108 of a vendor that sells merchandise over the Internet. In one example embodiment, client 102 is a personal computer that includes browser program 104 which facilitates communication and exchange of information with online store 108 at server 106.

In typical Internet transactions using a credit card, a user enters information at their local computer (e.g., client 102) and this information is transmitted via network 110 to server 106 and online store 108, which preferably comprises a website for a store where purchases and other transactions can be made. When a user finds merchandise the user wants to purchase, they typically enter sensitive personal information (such as name, address, billing address, contact information, credit card number, expiration date) and send this information across network 110 to online store 108. At online store, the merchant that owns online store 108 responds by storing the information, typically in a database. Upon completion of the transaction, the merchant bills the credit card company that issued the card and sends the purchased merchandise to the user. Typically, the user's personal information and credit card information are kept in a database of some sort. Most of such databases are also accessible by network connection, which facilitates their use in future transactions but also makes them susceptible to theft if the database security is compromised.

In a preferred embodiment of the present invention, a user does not send sensitive financial information (such as their personal credit card number) to the online store. Instead, upon finding merchandise to purchase, the user contacts their credit card company, for example, over a cell phone connection (note that other modes of communication can be implemented as well). In a preferred embodiment, some form of authentication and verification is used, such as the user entering a pre-registered pin number or other identifier. Upon proper authentication and verification, the user receives a temporary or one-time use credit card number, also referred to herein as a “disposable” credit card number, or as a disposable transaction identifier or account identifier, issued over the cell phone. The disposable number is preferably issued to the user on a display of the cell phone, or via voice over the cell phone. This disposable number is temporary only, and will expire or otherwise become invalid after a short duration of time (such as within 5-10 minutes of issuance) or immediately following a single transaction by the user, or upon some other predetermined limited duration or lifetime. In an alternative embodiment, the disposable number also has an expiration date and pin number similar to normal credit cards. In any case, the disposable number has only a short valid duration during which it can be used in a transaction.

The user enters the disposable number at the online store in lieu of the user's personal credit card number. For example, the user can enter the disposable number at the online store's website at checkout. The online store follows normal checkout procedures, charging the credit card company that issued the disposable number for the transaction. The credit card company in turn associates the disposable number with the user's account, and charges the user's account. Thus, the user interacts with an online store and makes a purchase without ever sending their credit card number to the online store.

In one preferred embodiment, the temporary credit card number is transmitted to a Bluetooth enabled cell phone or similar device. This device would communicate the credit card number wirelessly to the cash register in a brick and mortar store. For example, in one embodiment, the Bluetooth enabled device has a chip in it which is also registered or otherwise recognized by the credit card company (or other temporary number issuer), which would provide further verification of the transaction. For example, in digital transmissions, the temporary credit card number is digitally signed using a certificate issued by the credit card company. In this embodiment, a user of the Bluetooth enabled device could make a purchase at a brick and mortar store with a secure, one-time use or temporary number.

In an alternative embodiment, the online store not only charges the credit card company for the purchase, but also sends the merchandise directly to the credit card company. The credit card company, in turn, forwards the goods to the user. This embodiment allows the user to make a purchase at an online store without even submitting personal information such as an address or contact information, which is personal information that some users may wish to keep secret from vendors. In such embodiments, the credit card company may issue not only a disposable credit card number, but may also issue a temporary name and the shipping address of the company to the user via the above described channels, so that the user can enter that information at the online store rather than use their own name, shipping address, etc. Alternate embodiments can also include a shipping vendor who agrees to receive shipping information from the credit card company that associates random or false shipping information (or codes) with individuals. A database associating proxy shipping information and its relation to real users can be maintained at either the credit card company or the shipping company, or can be generated “on the fly” as the invention is used.

Another feature of preferred embodiments includes an additional piece of information associated with the temporary credit card number to provide additional security to the user. This additional information associates the temporary number with a particular transaction or at a specific store, so that if the number is intercepted somehow, it is of limited use to the snooper.

FIG. 2 shows an example implementation of the present invention. User 200 has accessible user cell phone 202 and personal computer (PC) 204. PC 204 has browser program 206 capable of communicating across network 212 with server 208 that hosts online store 210. Also preferably connected to network 212 is credit card company 214.

In a preferred embodiment, user 200 wishes to make a purchase at online store 210. User 200 uses PC 204 and browser 206 to access online store 210 on server 208. When user 200 has chosen items to purchase and is at a transaction or checkout page of online store 210 where credit card information can be entered, user 200 contacts credit card company 214 via cell phone 202 or using PC 204 and network connection 212. In either case, credit card company 214 preferably goes through a verification and authentication routine to make sure of user's identity. This can be as simple as identifying the owner of-cell phone 202, or may include requiring user 200 to enter a username and password, or other methods. User receives from credit card company 214 a temporary number such as a temporary credit card number with which to make the transaction at online store 210. In preferred embodiments, the temporary number is digitally signed by the issuer for security purposes. User 200 enters the temporary number at online store 210, which then bills credit card company 214 for the transaction. In alternate embodiments, user 200 receives from credit card company 214 further information, such as the shipping address of credit card company so that goods can be shipped directly to credit card company 214 instead of user 200. This allows user 200 to complete the transaction without entering any specific identifying information at online store 210. After a short duration (such as 5-10 minutes, though shorter or longer times may be used) or immediately following the transaction, the temporary number expires and can no longer be used in a transaction. In alternate embodiments, the user is allowed to specify the duration of the temporary number, within a maximum time limit or without.

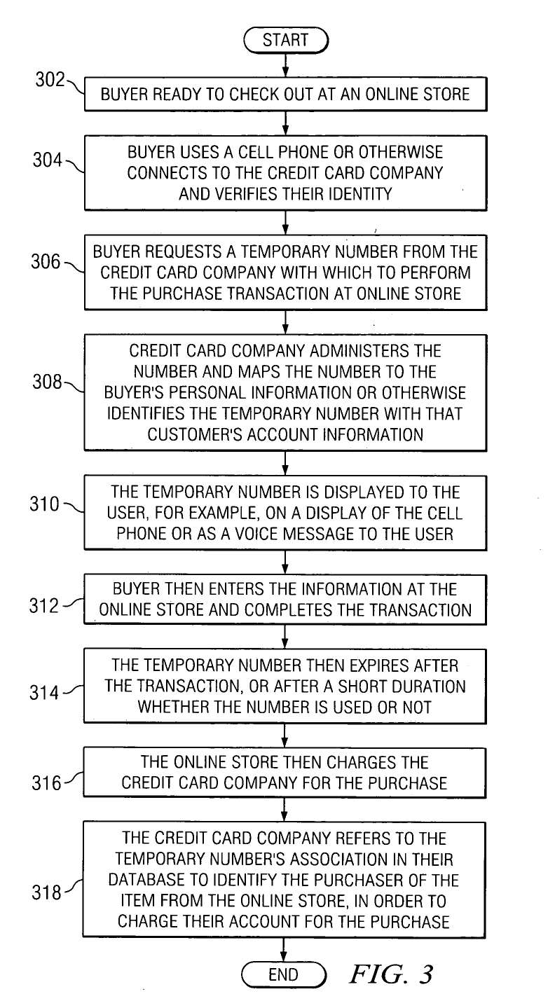

FIG. 3 shows a process flow for implementing a preferred embodiment of the present invention. The process begins with the buyer ready to check out at an online store, such as online store 210 (step 302). Buyer uses a cell phone or otherwise connects to the credit card company and verifies their identity (step 304). Buyer then requests a temporary number from the credit card company with which to perform the purchase transaction at online store (step 306). The credit card company issues the number to the user and maps the number to the buyer's personal information or otherwise identifies the temporary number with that customer's account information (step 308). This association preferably happens at the credit card company's database level only, so that only the credit card company has access to the customer's sensitive information. Next, the temporary number is displayed to the user, for example, on a display of the cell phone or as a voice message to the user (step 310). The buyer then enters the information at the online store and completes the transaction (step 312). The temporary number then expires after the transaction, or after a short duration whether the number is used or not (step 314). The online store then charges the credit card company for the purchase (step 316), and the credit card company refers to the temporary number's association in their database to identify the purchaser of the item from the online store, in order to charge their account for the purchase (step 318).

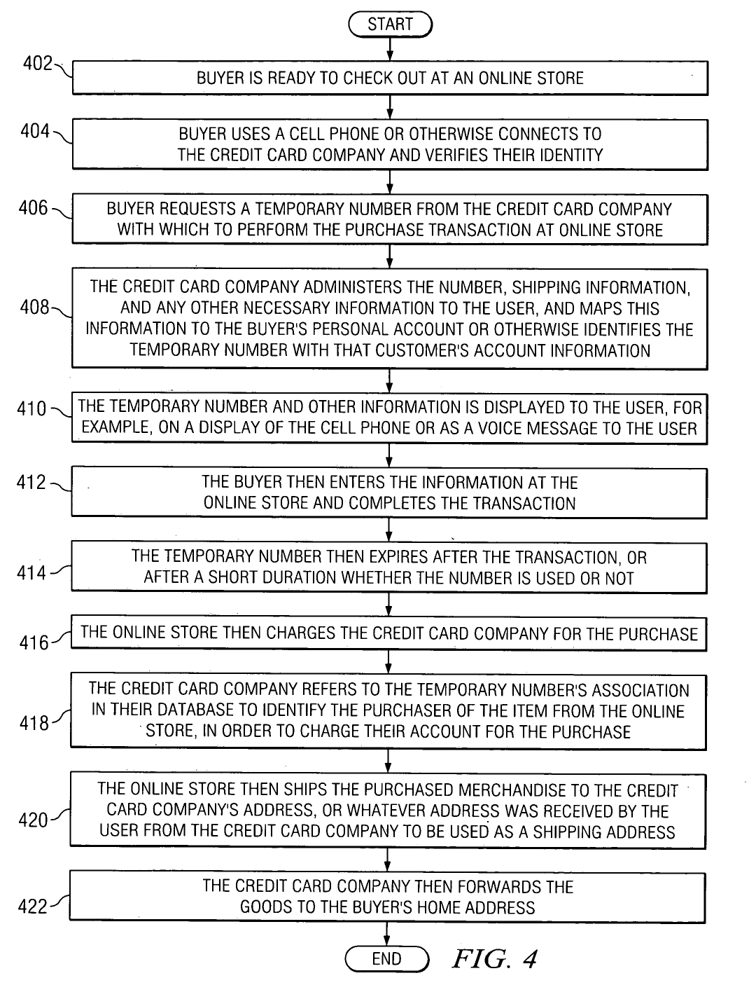

In an alternate embodiment, the credit card company issues more information to the user than just the temporary number. FIG. 4 shows such a process flow. The process begins with the buyer ready to check out at an online store, such as online store 210 (step 402). Buyer uses a cell phone or otherwise connects to the credit card company and verifies their identity (step 404). For example, systems such as caller ID can be used to determine the origin of a request. Buyer then requests a temporary number and other information from the credit card company with which to perform the purchase transaction at online store (step 406). This information, broadly referred to herein as the “temporary number” or “temporary purchase information”, preferably includes not only a disposable credit card number on which to charge the purchase, but also includes proxy information that is mapped at the credit card company to the purchaser's account, such as name, destination address, billing address, phone number, account number, expiration date, pin information, etc. The credit card company distributes the number, shipping information, and any other necessary information to the user, and maps this information to the buyer's personal account or otherwise identifies the temporary number with that customer's account information (step 408). This association preferably happens at the credit card company's database level only, so that only the credit card company has access to the customer's sensitive information. Next, the temporary number and other information is displayed to the user, for example, on a display of the cell phone or as a voice message to the user (step 410). The buyer then enters the information at the online store and completes the transaction (step 412). The temporary number then expires after the transaction, or after a short duration whether the number is used or not, whichever comes first (step 414). The online store then charges the credit card company for the purchase (step 416), and the credit card company refers to the temporary number's association in their database to identify the purchaser of the item from the online store, in order to charge their account for the purchase (step 418). The online store then ships the purchased merchandise to the credit card company's address, or whatever address was received by the user from the credit card company to be used as a shipping address (step 420). The credit card company then forwards the goods to the buyer's home address (step 422). Hence, the buyer can make a purchase and never enter personal information at the online store, keeping their personal information and association with the temporary number only in the credit card company's database. In some embodiments, such as where the user receives a dummy name from the credit card company and enters this information at the online store, the user can make the purchase in a completely anonymous way with respect to the online store.

It should be recognized that although specific hardware is referred to in the above description (e.g., cell phones, PCs, etc.), other hardware can be substituted without deviating from the innovations herein disclosed. For example, a palm top computer can be used by the user to complete the transactions, and the credit card company can be accessed by computer link rather than telephone link. In this disclosure, the term “cell phone” has been generically used to refer to any device capable of receiving such information from an issuer to the disposable information, including wireless PDAs, and tablet PCs, for example.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of making an online transaction, comprising the steps of:
receiving, at an issuer of disposable transaction information, a request from a user cell phone for disposable transaction information, wherein at least part of the disposable transaction information can be used as a disposable credit card number to make a purchase, and wherein the disposable credit card number will expire either after the purchase or after a predetermined time period elapses;
associating the disposable transaction information with an account of the user;
sending the disposable transaction information to a cell phone of the user.

2. The method of claim 1, wherein the user enters at least part of the disposable transaction information at an online store to make a purchase; and
wherein the online store charges the issuer of disposable transaction information for the purchase; and
wherein the issuer of disposable transaction information charges the user for the purchase.

3. The method of claim 2, wherein the issuer of the disposable transaction information also sends shipping information to the user;
wherein the user enters the shipping information at the online store; and
wherein the online store ships purchased merchandise according to the shipping information.

4. The method of claim 1, wherein the disposable transaction information is digitally signed when sent to the user cell phone.

5. The method of claim 1, wherein the user cell phone is capable of communicating on a local wireless network at a brick and mortar store;
wherein responsive to the issuer of disposable transaction information sending the disposable transaction information to the user cell phone, the user cell phone sends the disposable transaction information wirelessly to a cash register at the brick and mortar store.

6. The method of claim 5, wherein the local wireless network at the brick and mortar store is a Bluetooth enabled network.

7. The method of claim 1, wherein the disposable transaction information issuer is a credit card company.

8. The method of claim 1, wherein the user specifies a duration for the disposable transaction information.

9. A system for making a purchase, comprising:
a disposable information issuer communication system;
an online store, capable of communicating with the disposable information issuer;
wherein a user communicates a request to the disposable information issuer to request disposable information;
wherein the disposable information issuer associates the disposable information with the user and sends the disposable information to a cell phone of the user using the issuer communication system;
wherein the user uses the disposable information to make a purchase at the online store; and
wherein the disposable information expires either after the purchase or after a predetermined period of time elapses.

10. The method of claim 9, wherein a user of the user communication system enters the disposable information at the online store to make a purchase; and
wherein the online store charges the issuer of disposable information for the purchase; and
wherein the issuer of disposable information charges the user for the purchase.

11. The method of claim 10, wherein the issuer of the disposable information also sends shipping information to the user, and wherein the user enters the shipping information at the online store, and wherein the online store ships purchased merchandise according to the shipping information.

12. The method of claim 9, wherein the disposable information is digitally signed when sent to the user cell phone.

13. The method of claim 9, wherein the user cell phone is capable of communicating on a local wireless network at a brick and mortar store;
wherein responsive to the issuer of disposable information sending the disposable information to the user cell phone, the user cell phone sends the disposable information wirelessly to a cash register at the brick and mortar store.

14. The method of claim 13, wherein the local wireless network at the brick and mortar store is a Bluetooth enabled network

15. The method of claim 9, wherein the disposable information issuer is a credit card company.

16. A computer program product in a computer readable medium, comprising:
first instructions for receiving, at an issuer of disposable transaction information, a request from a user for disposable transaction information, wherein at least part of the disposable transaction information can be used as a disposable credit card number to make a purchase, and wherein the disposable credit card number will expire either after the purchase or after a predetermined time period elapses;
second instructions for associating the disposable transaction information with an account of the user;
sending the disposable transaction information to a cell phone of the user.

17. The computer program product of claim 16, wherein the user enters at least part of the disposable transaction information at an online store to make a purchase; and
wherein the online store charges the issuer of disposable transaction information for the purchase; and
wherein the issuer of disposable transaction information charges the user for the purchase.

18. The method of claim 17, wherein the issuer of the disposable transaction information also sends shipping information to the user;
wherein the user enters the shipping information at the online store; and
wherein the online store ships purchased merchandise according to the shipping information.

19. The method of claim 16, wherein the disposable transaction information is digitally signed when sent to the user cell phone.

20. The method of claim 16, wherein the user cell phone is capable of communicating on a local wireless network at a brick and mortar store;
wherein responsive to the issuer of disposable transaction information sending the disposable transaction information to the user cell phone, the user cell phone sends the disposable transaction information wirelessly to a cash register at the brick and mortar store.

21. The method of claim 16, wherein the local wireless network at the brick and mortar store is a Bluetooth enabled network.

22. The method of claim 16, wherein the disposable transaction information issuer is a credit card company.
